(19) United States
(12) Patent Application Publication
(10) Pub. No.: US 2011/0050761 A1
(43) Pub. Date: Mar. 3, 2011

(54) PIXEL CIRCUIT AND DISPLAY DEVICE

(75) Inventor: Teru YONEYAMA, Kanagawa (JP)

(73) Assignee: NEC Electronics Corporation, Kanagawa (JP)

(21) Appl. No.: 12/839,831

(22) Filed: Jul. 20, 2010

(30) Foreign Application Priority Data
Aug. 26, 2009 (JP) 2009-195929

(51) Int. Cl. G09G 5/02

(52) U.S. Cl. 345/698

(57) ABSTRACT

A display device uses a plurality of pixel circuits each of which includes a light-emitting element; a light-emission control switching element; a current control circuit for supplying a driving current, which corresponds to gray-level display data, to the light-emitting element via the light-emission control switching element; and a voltage control circuit, which includes a first capacitance element for storing a voltage corresponding to the gray-level display data, and controls ON/OFF operation of the light-emission switching element in accordance with the voltage stored. If the gray-level display data is data for causing the light-emitting element to display less than a certain luminance, the current control circuit supplies the light-emitting element with a constant driving current corresponding to the gray-level display data for displaying the certain luminance, and the voltage control circuit controls the ON time of the light-emission control switching element in accordance with a voltage stored.

### REFERENCE TO RELATED APPLICATION

This application is based upon and claims the benefit of the priority of Japanese patent application No. 2009-195929, filed on Aug. 26, 2009, the disclosure of which is incorporated herein in its entirety by reference thereto.

### TECHNICAL FIELD

This invention relates to a pixel circuit and display device. More particularly, the invention relates to a pixel circuit used in order to drive a display device such as an organic EL display device, and to the display device having this pixel circuit.

### BACKGROUND

An organic EL display makes it possible to obtain a high luminance with low power and excels in terms of viewability, response speed, service life and thinness. A current control method and a voltage control method are known as methods of driving the pixels in such an organic EL display.

In a case where a display device is driven using the current control method, the fact that current values corresponding to low-gray-level data are very small means that writing low-gray-level data to the pixel circuit takes a long period of time and it is difficult to realize a large-screen display device. In a case where a high-definition display device is driven, the time it takes to write data to one pixel short and therefore it is difficult to write low-gray-level data to the pixel circuit correctly. With a circuit that relies upon the voltage control method, on the other hand, a problem arises in terms of the quality of the display device owing to variations in threshold voltage (Vt) of the transistors for driving the light-emitting elements. Accordingly, systems (see Patent Documents 1 and 2) that combine the current control and voltage control methods have been proposed in order to improve upon the writing of low-gray-level data, which is a problem with the current control method.

According to Patent Document 1, the luminance of a light emission is adjusted based upon a light-emission interval controlled by the voltage control method. More specifically, bi-level data for controlling the firing and extinguishment of a light-emitting element is stored in a capacitance element as gray-level data for voltage control, current having a certain size is written using the current control method and the light-emission time of the light-emitting element with respect to low gray level is controlled by the voltage control method.

Patent Document 2 describes an electronic device in which voltage programming (voltage control) is performed by supplying a voltage signal to a holding capacitor via a second switching transistor, and current programming (current control) is performed by supplying a current signal to the holding capacitor via a first switching transistor.

### [Patent Document 1]

Japanese Patent Kokai Publication No. JP-P2004-184489A

### [Patent Document 2]

Japanese Patent Kokai Publication No. JP-P2007-164204A

### SUMMARY

The entire disclosure of Patent Documents 1 and 2 are incorporated herein by reference thereto.

The analysis below is provided in the present invention.

According to Patent Document 1, data stored by voltage control is stored only in the state of a bi-level value. As a consequence, information as to whether all of the light-emitting elements of a display device are to emit light or be extinguished is required to be written in a single horizontal scanning interval. It is necessary that gray-level data for voltage control and gray-level data for current control be written serially and that the firing and extinguishment of all light-emitting elements be controlled constantly. In a case where a large-size, high-definition display device is constructed, therefore, strict timing design is required and there is the danger that display quality will decline. Thus, there is much to be desired in the art.

A pixel circuit according to one aspect of the present invention comprises: a light-emitting element; a light-emission control switching element; a current control circuit that supplies a driving current, which corresponds to gray-level display data, to the light-emitting element via the light-emission control switching element; and a voltage control circuit, which includes a first capacitance element for storing a voltage corresponding to the gray-level display data, and controls ON/OFF operation of the light-emission switching element in accordance with the voltage stored. In a case where the gray-level display data is data for causing the light-emitting element to display less than a certain luminance, the current control circuit supplies the light-emitting element with a constant driving current corresponding to the gray-level display data for displaying the certain luminance. The voltage control circuit controls the ON time of the light-emission control switching element in accordance with a voltage stored.

The meritorious effects of the present invention are summarized as follows.

In accordance with the present invention, gray-level display data for voltage control is stored in a first capacitance element in analog fashion and therefore it is no longer necessary to manage the light-emission of the light-emitting element constantly. As a result, in a case where a large-size, high-definition display is constructed, timing design is given some latitude and a high-quality display is made possible.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a circuit diagram of a display device according to a first exemplary embodiment of the present invention;

FIG. 2 is a circuit diagram of a pixel circuit according to the first exemplary embodiment of the present invention;

FIG. 3 is a diagram illustrating the relationship between a triangular wave signal and output of an inverter circuit;

FIG. 4 is a first timing chart representing operation of the pixel circuit according to the first exemplary embodiment of the present invention;

FIG. 5 is a second timing chart representing operation of the pixel circuit according to the first exemplary embodiment of the present invention;

FIGS. 6A and 6B are diagrams illustrating the relationship between data write time and drive time; and

FIG. 7 is a circuit diagram of a pixel circuit according to a second exemplary embodiment of the present invention.

### PREFERRED MODES

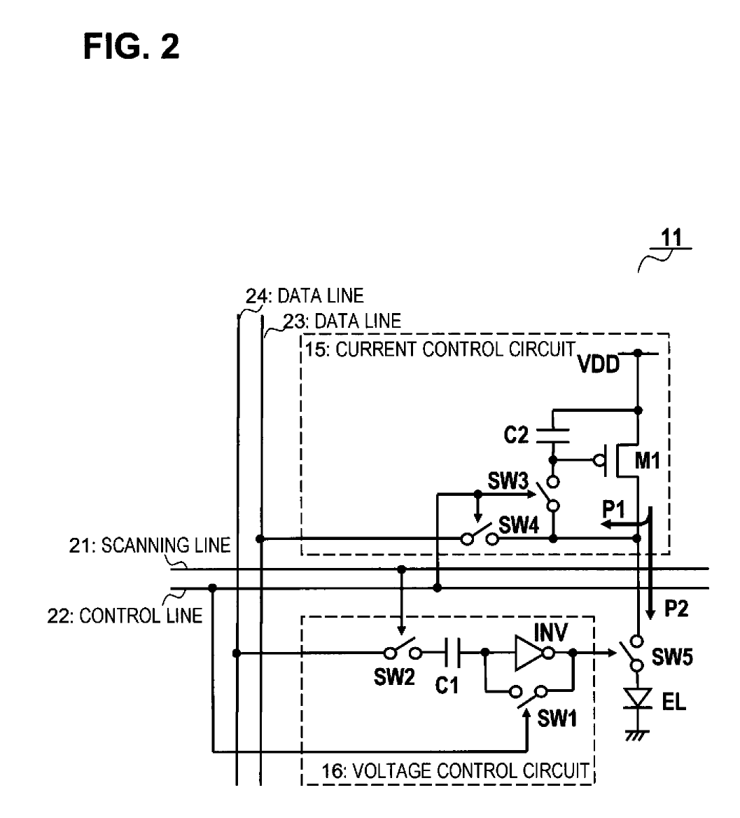

In the following disclosure of preferred modes, the reference symbols or numerals are shown merely by way of example with reference to the Drawings, only for better understanding of the modes, and should not be regarded as restrictive for the claimed subject matter. A pixel circuit according to a present mode comprises: a light-emitting element (EL, FIG. 2); a light-emission control switching element (SW5, FIG. 2); a current control circuit (15) for supplying a driving current, which corresponds to gray-level display data, to the light-emitting element via the light-emission control switching element; and a voltage control circuit (16, FIG. 2), which includes a first capacitance element (C1, FIG. 2) for storing a voltage corresponding to the gray-level display data, for controlling on/off operation of the light-emission switching element in accordance with the voltage stored. In a case where the gray-level display data is data for causing the light-emitting element to display less than a certain luminance, the current control circuit supplies the light-emitting element with a constant driving current corresponding to the gray-level display data for displaying the certain luminance, and the voltage control circuit sets the ON time of the light-emission control switching element in accordance conformity with the gray-level display data.

Preferably, in a case where the gray-level display data is data for causing the light-emitting element to display a luminance of the certain luminance or higher in the pixel circuit of the present invention, the current control circuit supplies the light-emitting element with a driving current proportional to the gray-level display data, and the voltage control circuit sets the ON time of the light-emission control switching element to a fixed time; and in a case where the gray-level display data is data for causing the light-emitting element to display a luminance less than the certain luminance, the voltage control circuit sets the ON time of the light-emission control switching element so as to be proportional to a voltage of the first capacitance element.

The voltage control circuit in the pixel circuit of a present mode may be adapted so as to set the ON time of the light-emission control switching element based upon whether or not the voltage of an input triangular wave signal for setting the ON time of the switch group has exceeded a voltage corresponding to the gray-level display data.

The voltage control circuit in the pixel circuit of a present mode may include: an inverter circuit (INV, FIG. 2) for controlling the ON/OFF operation of the light-emission control switching element; a first switch element (SW1, FIG. 2) connected across input and output ends of the inverter circuit; and a series circuit composed of the first capacitance element (C1, FIG. 2) and a second switch element (SW2, FIG. 2) and having a first end connected to the input end of the inverter circuit. A triangular signal may be supplied to a second end of the series circuit after the voltage corresponding to the gray-level display data is supplied; and the first and second switch elements may be turned ON in a period of time in which electric charge conforming to a voltage corresponding to the gray-level display data is stored in the first capacitance element, and the first switch element may be turned OFF and the second switch element turned ON in a period of time in which the triangular wave signal is supplied.

The current control circuit in the pixel circuit of a present mode may include: a second capacitance element (C2, FIG. 2) for storing electric charge that is proportional to the driving current; a first MOSFET (M1, FIG. 2) having a source connected to a power supply, a drain connected to the light-emitting element via the light-emission control switching element, and a gate, with the second capacitance element being connected across the source and the gate; a third switch element (SW3, FIG. 2) connected across the gate and drain of the first MOSFET; and a fourth switch element (SW4, FIG. 2) for turning ON and OFF supply of current corresponding to the gray-level display data to the drain of the first MOSFET; wherein the third and fourth switch elements are turned ON in a period of time in which electric charge is written to the second capacitance element.

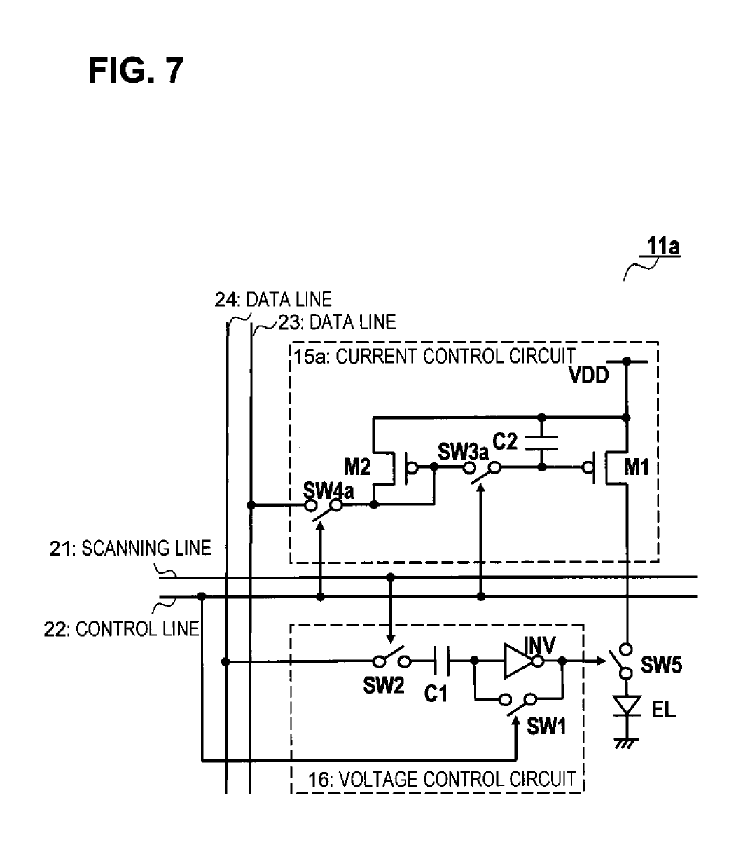

The current control circuit in the pixel circuit of the present mode may include: a second capacitance element (C2, FIG. 7) for storing electric charge that is proportional to the driving current; a first MOSFET (M1, FIG. 7) having a source connected to a power supply, a drain connected to the light-emitting element via the light-emission control switching element, and a gate, with the second capacitance element being connected across the source and the gate; a second MOSFET (M2, FIG. 7) of the same conductivity type as that of the first MOSFET and having a source connected to the power supply and a drain and gate that are connected in common (together); a third switch element (SW3a, FIG. 7) for connecting and disconnecting the gate of the first MOSFET and the gate of the second MOSFET; and a fourth switch element (SW4a, FIG. 7) for turning ON and OFF supply of current corresponding to the gray-level display data to the drain of the second MOSFET; wherein the third and fourth switch elements are turned ON in a period of time in which electric charge is written to the second capacitance element.

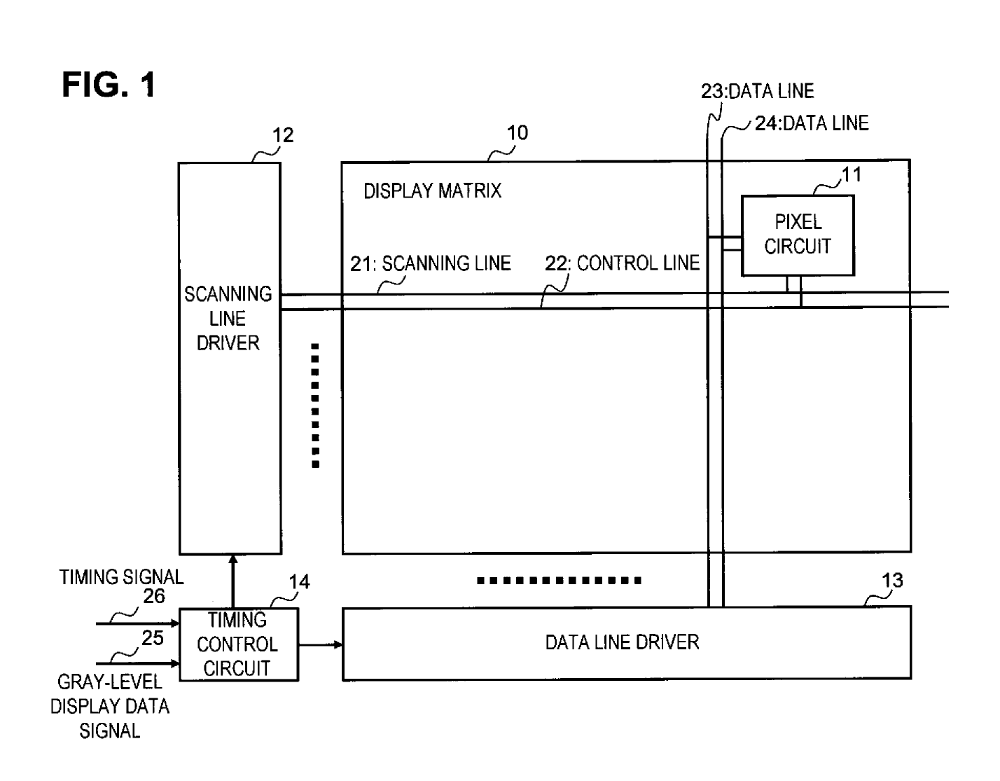

A display device according to a present mode may comprise: a pixel matrix (10, FIG. 1) in which the above-described pixel circuits (11, FIG. 1) are arranged in matrix form; a data line driver (13, FIG. 1) for supplying a plurality of the pixel circuits arranged in a column direction of the pixel matrix with a signal corresponding to gray-level display data; and a scanning line driver (12, FIG. 1) for supplying a plurality of the pixel circuits arranged in a row direction of the pixel matrix with a write timing signal, which is for writing a signal corresponding to the gray-level display data, and a timing signal regarding ON/OFF operation of the light-emission control switching element.

The scanning line driver in the display device of a present mode is such that after it performs writing control of each of the current control circuits and voltage control circuits in the pixel circuits in one or a plurality of rows in conformity with the gray-level display data, the scanning line driver controls each of the voltage control circuits so as to turn ON each of the light-emission control switching elements in the pixel circuits in the one or plurality of rows.

In accordance with the driving circuit described above, it is possible for voltage-control gray-level data and current-control gray-level data to be written simultaneously to a current control circuit and voltage control circuit, respectively. Furthermore, since the data for voltage control can be stored in analog fashion, it is no longer necessary to manage the light-emission of light-emitting elements constantly. As a result, timing in a large-size, high-definition display can be designed easier and it is possible to present a high-quality display.

Preferred exemplary embodiments of the present invention will now be described in detail with reference to the drawings.

### First Exemplary Embodiment

FIG. 1 is a circuit diagram of a display device according to a first exemplary embodiment of the present invention. The display device includes a display matrix 10, a scanning line driver 12, a data line driver 13 and a timing control circuit 14. The display matrix 10 has a plurality of pixel circuits 11 arrayed in the form of a matrix. The pixel circuits 11 are placed at respective ones of intersections where a scanning line 21 and control line 22, which are driven by the scanning line driver 12, perpendicularly intersect data lines 23, 24 driven by the data line driver 13. A gray-level display data signal 25 and a display-synchronizing timing signal 26 are input externally to the timing control circuit 14, which generates display information and timing information based upon the gray-level display data signal 25 and display-synchronizing timing signal 26 and applies this information to the scanning line driver 12 and data line driver 13.

FIG. 2 is a circuit diagram of the pixel circuit 11 according to the first exemplary embodiment of the present invention. The pixel circuit 11 includes a current control circuit 15, a voltage control circuit 16, a switch element SW5 and a light-emitting element EL, which is an organic EL element.

The current control circuit 15 includes a PMOS transistor M1, a capacitance element C2 and switch elements SW3, SW4. The PMOS transistor M1 has a source connected to a power supply VDD, a gate connected to its own drain via the switch element SW4, and a drain connected to the light-emitting element EL via the switch element SW5. The capacitance element C2 is connected across the gate and source of the PMOS transistor M1. The switch element SW4 is connected across the drain of the PMOS transistor M1 and the data line 23.

The voltage control circuit 16 includes an inverter circuit INV, a capacitance element C1 and switch elements SW1, SW2. The inverter circuit INV has an input end connected to the data line 24 via the capacitance element C1 and switch element SW2 and controls the ON/OFF operation of the switch element SW5 by a signal from the output end of the inverter. The switch element SW1 is connected across the input and output of the inverter circuit INV.

The switch elements SW1, SW2 and SW4 are turned ON and OFF under the control of the signal on the control line 22. The switch element SW2 is turned ON and OFF under the control of the signal on the scanning line 21. It is assumed that the switch elements SW1 to SW5 are constituted by FETs or the like.

Operation of the current control circuit 15 will be described first. When the switch elements SW3 and SW4 are ON, the PMOS transistor M1 is supplied with a display signal current (gray-level current), which corresponds to gray-level display data, from the data line 23. Since the gray-level current flows into the PMOS transistor M1 (along a path P1), a gate-source voltage necessary to pass this current is stored as gray-level data in the capacitance element C2, which is for gray-level control (the data storage takes place on the path P1). If the switch elements SW3, SW4 are subsequently turned OFF and the switch element SW5 turned ON, then a gray-level current conforming to the voltage of the capacitance element C2 flows into the light-emitting element EL and the latter emits light (path P2).

Operation of the voltage control circuit 16 will be described next. If switch element SW1 is ON, the voltages at the input and output of the inverter circuit INV are equal. The output (input) voltage of the inverter circuit INV at this time has a logically inverted threshold value Vt in terms of the voltage characteristic of the inverter circuit INV. If the switch element SW2 is ON at the same time, then a display voltage signal Vd corresponding to the gray-level data is input to the inverter from the data line 24. Accordingly, electric charge corresponding to Vt−Vd accumulates in the capacitance element C1, which is for gray-level control. By subsequently turning the switch element SW1 OFF, gray-level data for voltage control is stored in the capacitance element C1.

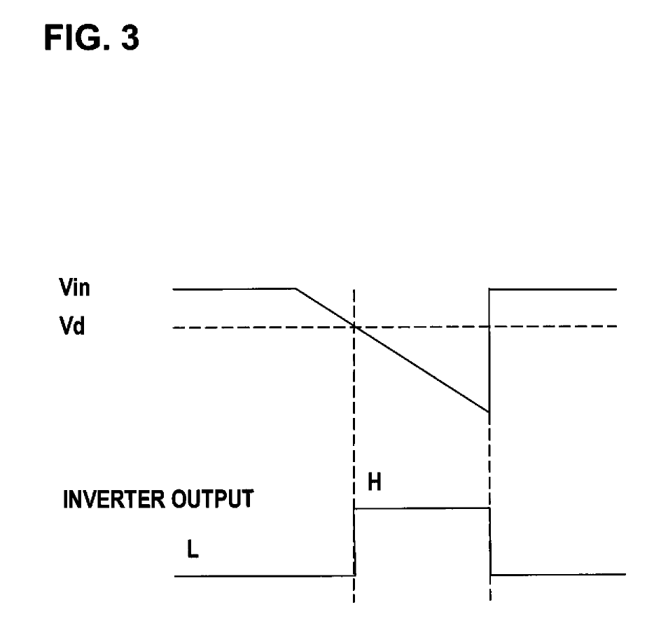

A method of controlling the switch element SW5 will now be described. The switch element SW5 is controlled by the output of the inverter circuit INV. Assume that the display voltage signal Vd has been stored in the capacitance element C1 as Vd−Vt, as described above. If a triangular wave signal Vin shown in FIG. 3 is applied to the data line 24 and Vin−(Vd−Vt) falls below Vt, i.e., if Vin is smaller than Vd, then the output of the inverter circuit INV changes from the low level (L) to the high level (H). At this time the switch element SW5 turns ON and the light-emitting element EL emits light for a period of time corresponding to the display voltage signal Vd. It is assumed that the switch element SW5 is in the OFF state if the output of the inverter circuit INV is in the vicinity of Vt.

With the current control method, gray-level current of low gray level is very small and therefore a very long period of time is required in order to store data in the capacitance element for gray-level control. If the display device is provided with a large screen and high definition, therefore, it is difficult to obtain excellent display quality. Accordingly, in a case where the light-emitting element is controlled at a low gray level, the voltage control method that causes the light-emitting element EL to emit light in the interval corresponding to the display signal voltage is used. In other cases, the method of control by current drive is used.

For example, control is performed using the voltage control method in a case where gray levels 0 to 7 are controlled, and using the current drive method in a case where gray levels 8 to 63 are controlled. In other words, for gray levels 0 to 7, the gray level is expressed by controlling the length of light-emission time. For gray levels 8 or higher, gray level is controlled by controlling the value of the current that flows into the light-emitting element EL. For example, in a case where light of gray level 8 is emitted, current of gray level 8 is stored (in the capacitance element C2) by voltage control and voltage of gray level 8 is stored (in capacitance element C1) by voltage control. Let Ta represent the length of the time emission by the light-emitting element EL (the time during which the output of the inverter circuit INV is at the H level). On the other hand, in a case where light of gray level 1 is emitted, current of gray level 1 is stored by the current control method and voltage of gray level 1 is stored by the voltage control method. If the length of time for gray level is ⅛×Ta, then the luminance of the light emission from the light-emitting element EL will be ⅛ of that for gray level 8 and, hence, gray level 1 can be expressed. It should be noted that ⅛ is assumed here for the sake of convenience. In an actual system, however, voltage can be stored in the capacitance element C1 in analog fashion and therefore the denominator is not limited to an integral number.

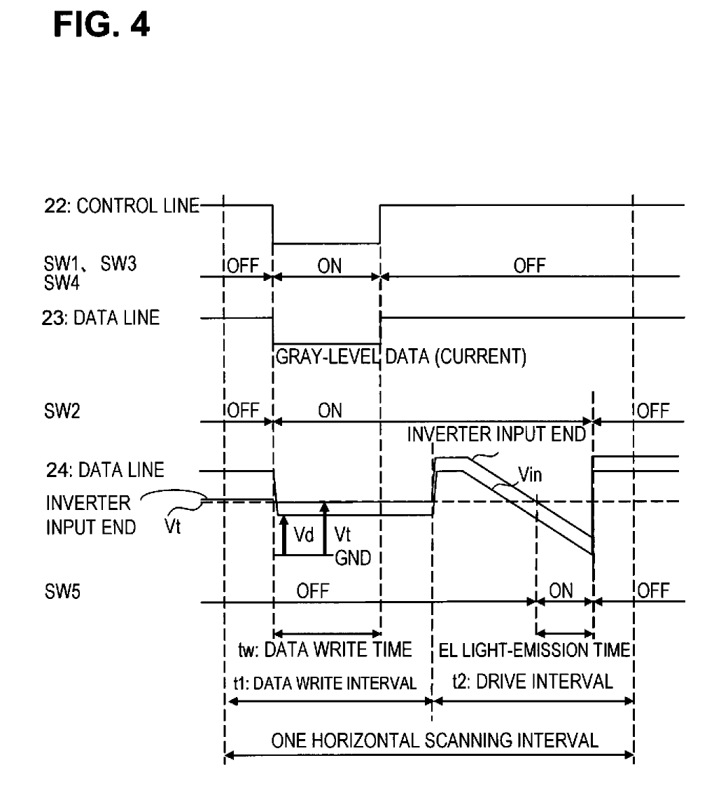

FIG. 4 is a timing chart representing operation of the pixel circuit according to the first exemplary embodiment of the present invention. If the signal on the control line 22 is at the low level in a data write interval t1 of one horizontal scanning interval, then the switch elements SW1 to SW4 turn ON. Accordingly, the PMOS transistor M1 is supplied with the gray-level signal (gray-level current) from the data line 23 and the signal is held in the capacitance element C2. Further, the capacitance element C1 is supplied with the gray-level signal (gray-level voltage equivalent to the display voltage signal Vd) from the data line 24 and the signal is held in the capacitance element C1. The voltage across the capacitance element C1 is Vd−Vt. The switch elements SW1, SW3, SW4 then turn OFF and the data write interval 1 ends.

In a drive interval t2 of one horizontal scanning interval, the switch element SW2 remains ON and the triangular wave signal Vin is supplied from the data line 24. Accordingly, the voltage at the input end of the inverter circuit INV becomes Vin−(Vd−Vt). When Vin−(Vd−Vt)<Vt holds at the decaying portion of the triangular wave signal Vin, the output end of the inverter circuit INV transitions to the high level (H), the switch element SW5 turns ON and the light-emitting element EL emits light. Then, at the rising edge of the triangular wave signal Vin, Vin−(Vd−Vt)>Vt holds, the output end of the inverter circuit INV transitions to the low level (L), the switch element SW5 turns off and the light-emitting element EL is extinguished.

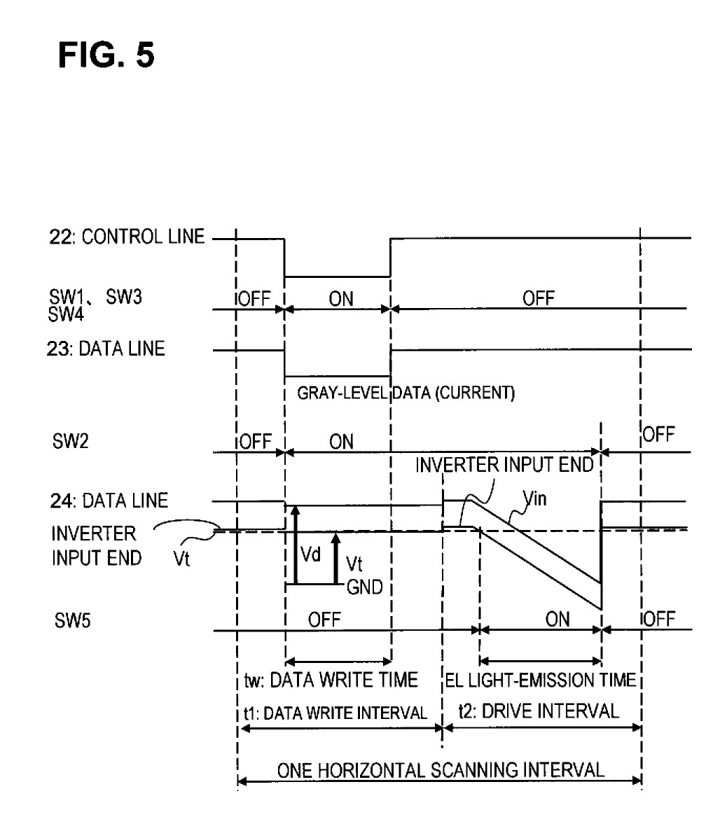

FIG. 5 is identical with FIG. 4 except for the fact that the value of Vd is larger, as a result of which the light-emission time of the light-emitting element EL is longer. FIG. 5 is a timing chart for a case where the value of Vd is maximum. In terms of the example set forth earlier, this corresponds to storing a voltage of gray level 8. In this case, Vin−(Vd−Vt)<Vt holds immediately after the start of decay of the triangular wave signal Vin. Accordingly, the light-emission time of the light-emitting element EL is longest.

In FIGS. 4 and 5, one horizontal scanning interval is divided into data write time and drive time. However, it is not necessary for data write time and drive time to be made to correspond to one horizontal scanning interval. That is, the light-emitting element may be made to emit light after a plurality of rows of data have been written.

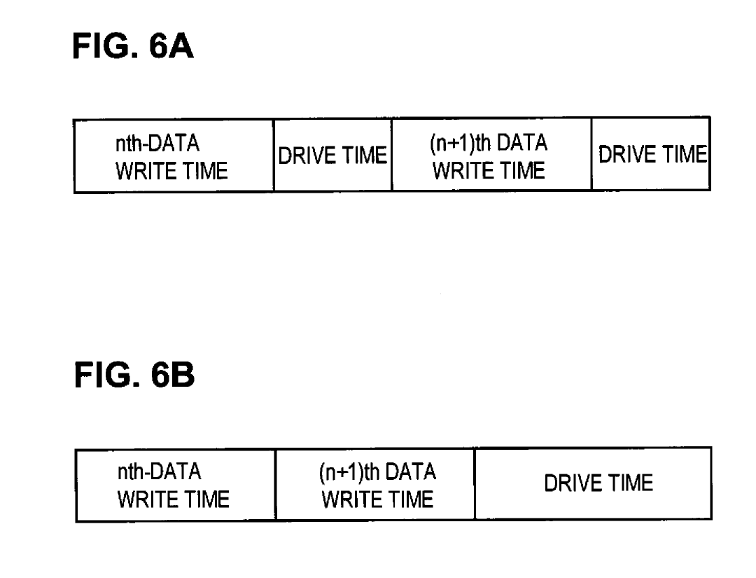

FIGS. 6A and 6B are diagrams illustrating the relationship between data write time and drive time. FIG. 6A illustrates an example in which one horizontal scanning interval is divided into data write time and drive time. FIG. 6B illustrates an example in which two horizontal scanning intervals are divided into data write time for two rows and time in a case where two rows are driven simultaneously or separately.

In accordance with the pixel circuit described above, as opposed to a pixel circuit in which control is performed by methods of two types, namely current control and voltage control, a data line for voltage control and a data line for current control are provided and data for voltage control is stored in the capacitance element C1 in analog fashion. Accordingly, information as to whether to light or extinguish all light-emitting elements of a display device is not required to be written in one horizontal scanning interval, and timing design is facilitated.

### Second Exemplary Embodiment

FIG. 7 is a circuit diagram of a pixel circuit according to a second exemplary embodiment of the present invention. Components in FIG. 7 identical with those shown in FIG. 2 are designated by like reference characters and need not be described again. A pixel circuit 11a shown in FIG. 7 is identical with the pixel circuit 11 with the exception of a current control circuit 15a. Accordingly, the voltage control circuit 16 and its overall operation need not be described.

The current control circuit 15a includes PMOS transistors M1, M2, capacitance element C2 and switch elements SW3a, SW4a. The PMOS transistor M1 has a source connected to power supply VDD, a gate connected to the drain of the PMOS transistor M1 via the switch element SW3a and a drain connected to the light-emitting element EL via the switch element SW5. The capacitance element C2 is connected across the gate and source of the PMOS transistor M1. The PMOS transistor M2 has a source connected to the power supply VDD, a drain connected to the data line 23 via the switch element SW4a, and a gate connected to the drain.

The pixel circuit 11a constructed as set forth above is such that the PMOS transistors M1, M2 form a current mirror when the switch elements SW3a, SW4a are ON. Gray-level current supplied from the data line 23 therefore flows into the PMOS transistor M1 as a mirror current. The gate-source voltage necessary in order to pass this gray-level current is stored in the capacitance element C2 as electric charge representing gray-level data. If the switch elements SW3a, SW4a are subsequently turned OFF and the switch element SW5 turned ON, the desired gray-level current flows into the light-emitting element EL and the light-emitting element EL emits light.

In accordance with this embodiment, the fact that the current control circuit 15a has the configuration of a current mirror means that the current of the gray-level signal that flows into the light-emitting element EL can be enlarged by changing the mirror ratio.

The disclosures of the patent documents cited above are incorporated herein by reference thereto. Within the bounds of the full disclosure of the present invention (inclusive of the scope of the claims), it is possible to modify and adjust the modes and embodiments of the invention based upon the fundamental technical idea of the invention. Multifarious combinations and selections of the various disclosed elements are possible within the bounds of the scope of the claims of the present invention. That is, it goes without saying that the invention covers various modifications and changes that would be obvious to those skilled in the art within the scope of the claims.

What is claimed is:

1. A pixel circuit, comprising:
a light-emitting element;
a light-emission control switching element;
a current control circuit that supplies a driving current, which corresponds to gray-level display data, to said light-emitting element via said light-emission control switching element; and
a voltage control circuit, which includes a first capacitance element for storing a voltage corresponding to the gray-level display data, and controls ON/OFF operation of the light-emission switching element in accordance with the voltage stored;
wherein in a case where the gray-level display data is data for causing said light-emitting element to display less than a certain luminance, said current control circuit supplies the light-emitting element with a constant driving current corresponding to the gray-level display data for displaying the certain luminance, and said voltage control circuit controls the ON time of said light-emission control switching element in accordance with a voltage stored.

2. The circuit according to claim 1, wherein in a case where the gray-level display data is data for causing said light-emitting element to display a luminance of said certain luminance or higher, said current control circuit supplies said light-emitting element with a driving current proportional to the gray-level display data, and said voltage control circuit sets the ON time of the light-emission control switching element to a fixed time; and
in a case where the gray-level display data is data for causing said light-emitting element to display a luminance less than said certain luminance, said voltage control circuit sets the ON time of said light-emission control switching element so as to be proportional to a voltage of the first capacitance element.

3. The circuit according to claim 1, wherein said voltage control circuit is adapted so as to set the ON time of said light-emission control switching element based upon whether or not the voltage of an input triangular wave signal for setting the ON time of said switch group has exceeded a voltage corresponding to the gray-level display data.

4. The circuit according to claim 2, wherein said voltage control circuit is adapted so as to set the ON time of said light-emission control switching element based upon whether or not the voltage of an input triangular wave signal for setting the ON time of said switch group has exceeded a voltage corresponding to the gray-level display data.

5. The circuit according to claim 3, wherein said voltage control circuit includes:
an inverter circuit INV for controlling ON/OFF operation of said light-emission control switching element;
a first switch element connected across input and output ends of said inverter circuit; and
a series circuit composed of said first capacitance element and a second switch element and having a first end connected to the input end of said inverter circuit;
wherein a triangular signal is supplied to a second end of said series circuit after a voltage corresponding to the gray-level display data is supplied; and
said first and second switch elements are turned ON in a period of time in which electric charge conforming to the voltage corresponding to the gray-level display data is stored in said first capacitance element, and said first switch element is turned OFF and said second switch element turned ON in a period of time in which the triangular wave signal is supplied.

6. The circuit according to claim 2, wherein said current control circuit includes:
a second capacitance element for storing electric charge that is proportional to the driving current;
a first MOSFET having a source connected to a power supply, a drain connected to said light-emitting element via said light-emission control switching element, and a gate, with said second capacitance element being connected across the source and the gate;
a third switch element connected across the gate and drain of said first MOSFET; and
a fourth switch element for turning ON and OFF supply of a current corresponding to the gray-level display data to the drain of said first MOSFET;
wherein said third and fourth switch elements are turned ON in a period of time in which electric charge is written to aid second capacitance element.

7. The circuit according to claim 2, wherein said current control circuit includes:
a second capacitance element for storing electric charge that is proportional to the driving current;
a first MOSFET having a source connected to a power supply, a drain connected to said light-emitting element via said light-emission control switching element, and a gate, with said second capacitance element being connected across the source and the gate;
a second MOSFET of the same conductivity type as that of said first MOSFET and having a source connected to the power supply and a drain and gate that are connected in common;
a third switch element for connecting and disconnecting the gate of said first MOSFET and the gate of said second MOSFET; and
a fourth switch element for turning ON and OFF supply of current corresponding to the gray-level display data to the drain of said second MOSFET;
wherein said third and fourth switch elements are turned ON in a period of time in which electric charge is written to said second capacitance element.

8. A display device, comprising:
a pixel matrix in which a plurality of the pixel circuits set forth in claim 1 is arranged in matrix form;
a data line driver for supplying a plurality of said pixel circuits arranged in a column direction of said pixel matrix with a signal corresponding to gray-level display data; and
a scanning line driver for supplying a plurality of said pixel circuits arranged in a row direction of said pixel matrix with a write timing signal, which is for writing a signal corresponding to the gray-level display data, and a timing signal regarding ON/OFF operation of said light-emission control switching element.

9. The device according to claim 8, wherein after performing writing control of each of said current control circuits and voltage control circuits in said pixel circuits in one or a plurality of rows in conformity with the gray-level display data, said scanning line driver controls each of said voltage control circuits so as to turn ON each of said light-emission control switching elements in said pixel circuits in the one or plurality of rows.
